(19) United States
(12) Patent Application Publication
(10) Pub. No.: US 2005/0278873 A1
(43) Pub. Date: Dec. 22, 2005

(54) Gamma acid type reactive dye

(75) Inventors: Yu-Chou Chao, Taipei City (TW); Yi-Fen Chiang, Taipei City (TW)

Correspondence Address: APEX JURIS, PLLC, 13194 EDGEWATER LANE NORTHEAST, SEATTLE, WA, 98125, US

(73) Assignee: National Taipei University Technology, Taipei City (TW)

(21) Appl. No.: 10/869,132

(22) Filed: Jun. 16, 2004

(51) Int. Cl. C09B 62/00

(52) U.S. Cl. 8/543

(57) ABSTRACT

The invention relates to reactive dyes for ink-jet printing. A series of reactive monoazo dyes derived from γ acid were synthesized, the printing quality of the inks made from the dyes were evaluated and compared with those of the commercial inks. The materials printed include photo papers, glossy papers, A4 papers and pretreated cotton. Based on the data of CIE Lab, it is found that inks made from the inventive dyes have smaller ΔE and better fastness against water and light. The printing quality of the inventive inks is better than those of the commercial inks. The inventive dyes can solve current problems such as complicate operation process and the treatment required for high polluted waster water produced associated with the conventional printing industry, such that not only the cost and time are saved, but also the demand of diversity required by customers can be satisfied.

### BACKGROUND OF THE INVENTION

1. Field of the invention

The invention relates to a γ acid type reactive dye, and particularly, to a γ acid type reactive dye characterized in that it has a shade close to standard magenta, exhibits excellent water fastness and sunlight fastness, and is suitable for inkjet printing or inkjet stamping on fibrous material.

2. Description of the prior art

In recent years, about 3×10¹² m² of printed textiles were produced every year worldwide. Cotton and cotton/polyester fabrics comprised of more than 70% of these. Coloring materials used therefor were mostly pigments (comprising 65%), as well as other dyes, such as, reactive dyes (15%), disperse dyes (10%), and also acid dyes and other dyestuffs (10%).

Inkjet printing exhibits relatively good market potential due to its diversity, short operation time and ease modification on patterns. However, since the speed of inkjet printing is slower than that of conventional printing, inkjet printing is used at present for drafting and production of small amount and rarely for mass production. Nevertheless, due to the development of a number of hardwares, the speed of inkjet printing is greatly improved to an extent for taking small and medium amount production. The major material consumed in inkjet printing is dye which affects the production cost and the quality of products. Accordingly, the development of suitable dyes not only can push up effectively the inkjet industry, but also meets the requirement of E-textile business and consequently creates the vitality of textile industry.

Conventional inks for ink-jet printing can be classified into oil type, aqueous type and hot-melt type. Inks used in office inkjet printer consist mainly of aqueous type ink whose main component is dye. Although it exhibits poor water fastness and light fastness, many advantages such as, for example, wider color gamut, higher brightness and chroma, as well as good reproducibility and non-toxic, make aqueous type ink being prevailed at present.

Aqueous type ink is composed typically of following substances:
(1) Colorant, functioning for providing the ink a color variation.
(2) Solvent, for dissolving or dispersing colorant.
(3) Surfactant, for. lowering surface tension and increasing wettability.
(4) Humectant, for suppressing the evaporation of the ink.
(5) Penetrant, for allowing the ink penetrate more quickly into the substrate.
(6) Viscosity modifier, for adjusting the viscosity of the ink.
(7) Dye solubilizer, for increasing the solubility of the dye.
(8) Dispersant, for facilitating the homogenization of dye colloid.
(9) Fixative, for improving the performance of the pattern.
(10) pH Buffer, for adjusting the pH of the ink such that the dye can be dissolved more easily or dispersed more uniformly.
(11) Chelating agent, for complexing metal ions (especially calcium ion).
(12) Biocide, for killing bacteria and preventing the growth of organisms in the ink.
(13) Hot-melt vehicle, for using in a hot melt type ink system.
(14) Plasticizer, for adding in a hot melt type ink to improve the flexibility of pattern and lower the viscosity.
(15) UV-blocker, for increasing the light fastness of the dye contained in the jet-printed pattern.
(16) Anticockle, for reducing the cross-linking between paper fibers to prevent wrinkling of the paper.
(17) Nucleation aide, used in hot bubble jet printing system for improving the nucleation of bubbles so as to increase the efficiency of jet printing.
(18) Antikogation aide, used in hot bubble jet printing system for preventing kogation of the ink.
(19) Free-radical inhibitor, for reducing the degradation of the dye to improve the storage stability of the ink.
(20) Antioxidation agent, having same function as the free-radical inhibitor.

Magenta monoazo dyes derived from γ acid have a higher light fastness with dull shade. The number and position of functional groups can be adjusted to increase the brilliance of the dye and to synthesize a magenta reactive dye with pure shade and brilliant chroma as well as excellent all-round fastness properties, which, not only can be formulated into a ink suitable for inkjet printing, but also can facilitate the improvement on inkjet printing technology and the level of quality of the print.

### SUMMARY OF THE INVENTION

One object of the invention is to provide a γ acid type reactive dye useful for magenta inkjet dyes by combining various diazo components and γ acid.

Another object of the invention is to provide a γ acid type reactive dye, characterized in that, when it is used in a ink and is jet printed on cotton fabrics and various papers, the shade obtained is closer to standard magenta than that from commercial ink.

Still another object of the invention is to provide a γ acid type reactive dye, characterized in that its all-round fastness properties are higher than those of commercial inks, meet commercial requirements, and can solve effectively problems of impure shade and poor fastness associated with the present jet print ink.

In order to achieve the above-described objects, a γ acid is reacted with an aromatic primary amine to give a monoazo dye which after a reduction reaction, was subjected to an additive elimination reaction successively with cyanuric chloride and 2-aminoethane-sulphonic acid to obtain a series of reactive dyes having the following general structure:

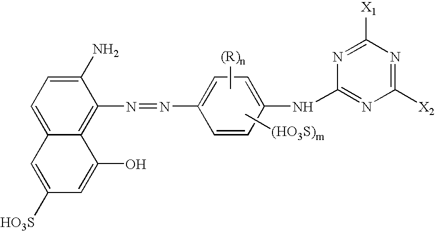

wherein R may be C1-C4 alkyl, C1-C4 haloalkyl, C1-C4 alkoxy group or cyano group; n is 0, 1 or 2; m is 0, 1 or 2; m and n is independently with each other and may be identical or different; X₁ and X₂ may be a halogen (e.g., chlorine, fluorine), 2-aminoethane-sulfonic acid or α-aminobenzene-sulfonic acid.

Thereafter, the dye thus obtained can be formulated into ink and is used to jet print with an EPSON 400 printer on a photographic paper, glossy paper, common A4 paper and a pretreated cotton fabric. The shade and fastness properties of prints were analyzed and results obtained indicated that inks prepared according to the invention exhibited better magenta shade and higher water fastness and light fastness than those obtained from commercial inks.

### DETAILED DESCRIPTION OF THE PREFERRED EMBODIMENT

Hereinafter, the invention will be described with reference to its some preferred embodiments.

A. Preparation of Dyes

An monoazo dye is firstly prepared from a γ acid and an aromatic primary amine. This monoazo dye is subjected to a reduction reaction, followed by additive elimination reaction successively with cyanuric chloride and 2-aminoethane-sulphonic acid to prepare a series of reactive dyes according to the following scheme: 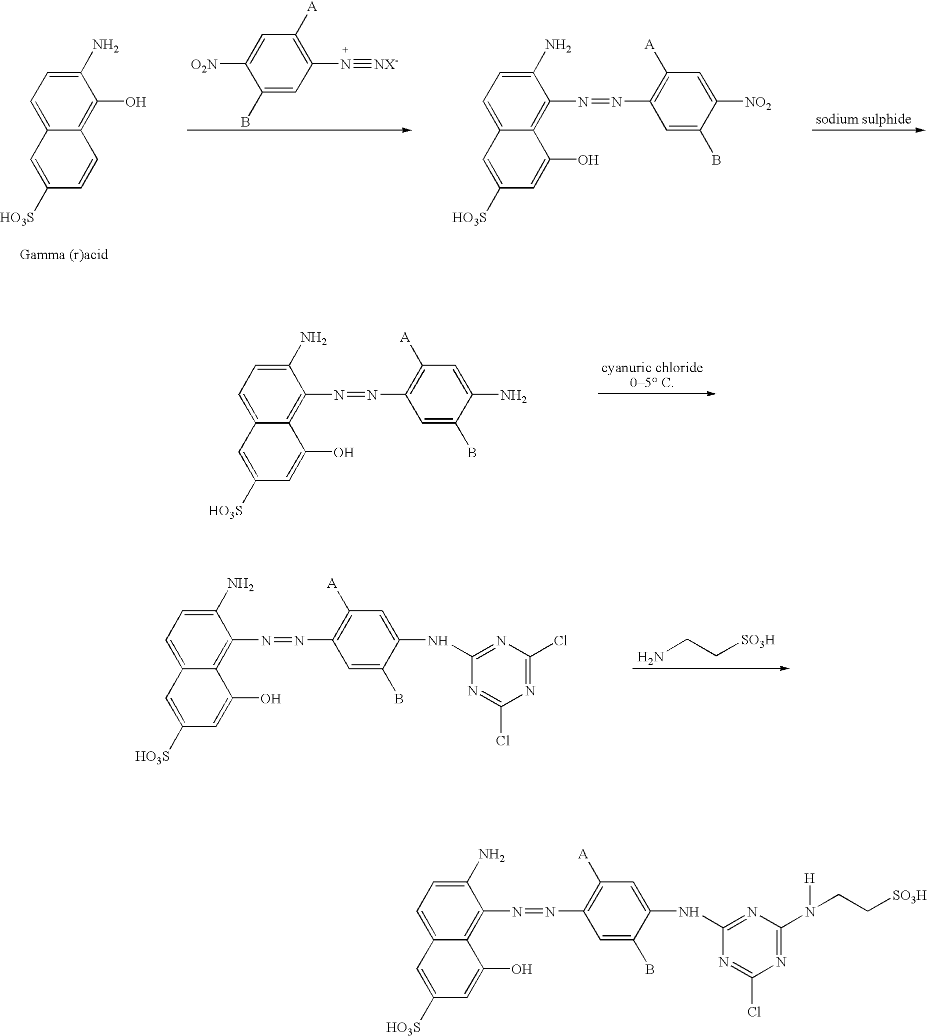
1. Preparation of Dye A
(1) Diazotization Reaction

4.80 g (0.02 mole) of p-Nitroaniline-o-sulfonic acid was weighed, added in 80 ml of distilled water and dispersed under stirring. 0.14 g of NaNO₂ was weighed, added in 10 ml of distilled water and stirred to dissolve it. The reaction mixture was poured into a mixture of 6.0 ml HCl (32%) and 40.00 g crushed ice. After mixing homogeneously, the mixture was added dropwisely into the above dispersion. The reaction mixture was stirred continuously for about 1 hour while keeping the reaction temperature below 5° C. A pale yellow bright crystal was then appeared. After confirming the completeness of the reaction by testing with H acid and I.P. solution (4-N,N-diethylaminobenzaldehyde/Acetic acid), an excess amount of sulfamic acid was added to remove residual NaNO₂ (colorless under testing with KI-starch paper).

The reaction solution was filtered and the product on the filter was added in 100 ml of distilled water, dispersed by stirring and then placed in a ice bath to keep the temperature below 5° C.

(2) Coupling Reaction

5.08 g Gamma acid (γ acid ) was weighed, added in 100 ml of distilled water and stirred thoroughly. The pH of the solution of adjusted to 8.0, the solution became clear brown due to the coupling component. This solution was added dropwisely into the solution prepared in the above step (the diazo salt). After 30 minutes, the reaction solution became deep purple, and was confirmed by test to be completely reacted. 15.00 g NaCl was added to isolate the dye and 9.00 g of purple solid (dye A1) was obtained. Thin layer chromatography (eluent: isopropanol/n-butanol/ethyl acetate/water=20/40/10/30) detected a purple spot (Rf=0.79).

(3) Reduction Reaction

6.40 g Na₂S.9H₂O was added in 50 ml of distilled water, stirred to dissolve and then added slowly into the aqueous solution prepared in the previous step (dye A1). The temperature of the resulting solution was raised to 50° C., and the pH was controlled at about 8.5 with dilute HCl. After 30 minutes, the solution turned out to be red, and was confirmed to be reacted completely. 37% HCl was added to isolate the dye and 8.50 g of dye A2 was obtained as goldish yellow solid. Thin layer chromatography with same eluent as above detected a red spot (Rf=0.72).

(4) Additive Elimination (I)

3.90g of Cyanuric chloride was added in 50 ml of acetone to dissolve it and the resulting solution was poured into the previous aqueous solution (dye A2). The temperature of the resulting solution was kept to be below 5° C., and its pH value was controlled at 8.0. After 30 minutes, the reaction solution turned from red to bright reddish purple. 11.20 g Reddish purple solid (dye A3) was obtained by salting out. Thin layer chromatography with same eluent detected a bright reddish purple spot (Rf=0.79).

(5) Additive Elimination Reaction (II)

2.65 g of 2-Aminoethane-sulfonic acid was added in 20 ml of distilled water, stirred to dissolve and then added into the aqueous solution prepared in the previous step (dye A3). The temperature of the resulting solution was raised to 30˜40° C., and its pH was adjusted to 7.0. After 60 minutes, the reaction was complete and the solution was salted out to obtain 14.52 g of reddish purple crystal (Dye-A). Thin layer chromatography with same eluent detected a bright reddish purple spot (Rf=0.75).

2. Preparation of Dye E′ and G

The same procedure as in the preparation of Dye-A was followed, except 4.80 g of p-nitroaniline-o-sulfonic acid was replaced with 4.56 g of 2-amino-5-nitrobenzotrifluoride to get 11.20 g of Dye-E′, and with 3.20 g of p-nitroaniline to get 9.50 g of Dye-G∘

3. Preparation of Dye-C

(1) Diazotization

3.26 g (0.02 mole) of 2-Amino-5-nitrobenzonitride was added in 80 ml H₂SO₄(98%) and the temperature of the resulting mixture was raised to 40° C. to dissolve it. The solution was left stand to room temperature. Then, 0.14 g NaNO₂ was weighed and added in 10 ml H₂SO₄ (98%). The temperature of the mixture was raised to 40° C. and the mixture was stirred to dissolve the NaNO₂. The solution was left stand to room temperature and was added dropwisely into crushed ice (about 40 g). The solution was stirred continuously at below 5° C. for about 60 minutes. The solution prepared previously was added slowly therein and stirred at 5° C. continuously till the reaction became complete.

(2) Coupling, reduction and additive elimination were performed under same conditions as those steps (2), (3), (4), and (5) used in the preparation of Dye-A to get 11.06 g of Dye-C.

4. Preparation of Dye-E

A solution E2 was prepared as the steps (1) and (2) used in the preparation of Dye-A. 3.46 g of Metanilic acid was dissolved in 50 ml of distilled water. 3.90 g of Cyanuric chloride was dissolved in 50ml of acetone and added dropwisely into the Metanilic acid solution. The temperature of the resulting solution was kept below 5° C., and its pH was controlled at 8.0. This solution was added into the E2 solution. The temperature of the resulting solution was raised to 30° C., while the pH was maintained at 8.0. After stirring for about 60 minutes, the reaction was complete. 15.32 g of Reddish purple crystal (Dye-E) was salted out. Thin layer chromatography with same eluent detected a red spot (Rf=0.62)

TABLE 1
Thin layer chromatography (TLC) of the reaction solution of dyes

| | | | | | Additive | | Additive | |
|---|---|---|---|---|---|---|---|---|
| | Coupling | | Reduction | | elimination | | elimination | |
| Inventive | reaction | | reaction | | reaction (1) | | reaction (2) | |
| dye | Rf | Color | Rf | Color | Rf | Color | Rf | Color |
| A | 0.79 | Deep | 0.72 | Red | 0.79 | Magenta | 0.75 | Magenta |
| | | purple | | | | | | |
| C | 075 | Blue | 0.70 | Bluish- | 0.76 | Purple | 0.65 | Purple |
| | | | | purple | | | | |
| E | 0.55 | Deep | 0.48 | Red | — | — | 0.62 | Magenta |
| | | purple | | | | | | |
| E′ | 0.55 | Deep | 0.48 | Red | 0.67 | Magenta | 0.65 | Magenta |
| | | purple | | | | | | |
| G | 0.76 | Bluish- | 0.71 | Bright | 0.75 | Dark | 0.70 | Orange |
| | | purple | | orange | | orange | | |

B. Ink-Jet Printing and Testing

Since piezoelectric ink-jet printing system is less susceptible to the blockage of nozzle by the ink and its nozzle needs not to be replaced, it is considered commonly that the piezoelectric system will become the mainstream in the ink-jet printing system for textiles. In view of this, an Epson 400 piezoelectric type printer was used in this work.

1. Ink-jet printing

The ink was filtered through a 0.45μ mPVDF filtering membrane and then was packed in an evacuated EPSON 400 monochromatic ink box. Four substrates, i.e., photographic papers, glossy papers, common A4 papers, and pretreated cotton fabrics, were printed, respectively.

2. Test of Properties of Inks

Dyes were formulated into inks, and properties thereof were tested, such as, the viscosity, surface tension, concentration, pH, and the like. In addition, shade and fastnesses against light and washing of prints obtained from the inventive inks were compared with those from commercial inks.

(1) Viscosity

Ink was placed in a small rotating dish. The rotational speed and the upward gradient of the rotational speed was set such that the rotational speed will increase from low speed to high speed gradually, while the viscosity will decrease correspondingly, and an equilibrium state will reached finally. An equilibrium values as the viscosity value of the ink was obtained the by plotting with viscosity (cp) as the .Y axis and the rotational speed (rpm) as the X axis.

(2) Surface Tension (dyne/cm)

Measurements of the radius r (cm) of the capillary, the height of the solution surface h (cm) and the density ρ (g/cm³ ) of the ink were substituted into the following equation to obtain the value of surface tension (σ)∘

$$σ = \frac{r ( h + r / 3 ) \times ρ \times g}{2}$$

σ (dyne/cm): surface tension
r (cm): radius of the capillary
h (cm): height of the liquid surface
ρ (g/cm³): density
g (dyne/g): acceleration of gravity
   (3) Centrifugation Test

The ink was centrifuged at rotational speed of 10 (the maximum speed) for 30 minutes and was observed whether settlement was occurred. No settlement means that the ink exhibited a satisfactory storage stability.

C. Tests of Properties of Ink-Jet Printed Substrate

After ink-jet printing, the cotton fabric was fixed and tested with respect to following properties.

1. Fastness

(1) Water Fastness: AATCC107-1991

Cotton fabric was cut into specimens of 5.7×5.7 cm, and sewed with multifiber test fabric with same dimension. Test specimens were immersed in water, removed and stripped off excess water till wet weight is 2.5 times the dry weight. Each specimen was fixed by clamping with acrylic plates on both sides. A 4.5 kg weight was loaded on the specimen and then placed as a whole in an oven at 38±2° C. for 18 hours. Remove specimen from unit and complete drying by hanging in air at room temperature. Classify the effect on the color of the test specimens by the Gray Scale for Color Change. Classify the staining of the multifiber test fabric by the Gray Scale for Staining (AATCC, rank 5 is the best).

(2) Washing Fastness: AATCC61-1993, 3A

Cotton fabric was cut into specimens of 5.0×15.0 cm, and sewed with multifiber test fabric with same dimension. Test specimen was placed in a steel cylinder together with 50 ml of soap solution [0.2 (wt)%] and 100 steel beads. After heating at 71° C. for 45 minutes, the test specimen was removed and rinsed in distilled water at 40° C. for one minute three times. Remove excess water and complete drying by hanging in air at room temperature. Classify the effect on the color of the test specimens by the Gray Scale for Color Change. Classify the staining of the multifiber test fabrics by the Gray Scale for Staining (AATCC, rank 5 is the best).

(3) Light Fastness: ISO 105-A03

Specimens of 4.0×10.0 cm were cut, and clamped between iron racks in the light fastness tester. After irradiated for 20 hours, test specimens were removed. Color difference (ΔE) was measured with a spectrophotometer on the specimens with reference to test specimens before irradiation. Ranks were evaluated based on the criteria listed in Table 2 (Rank 1 is the worst and rank 5 is the best).

TABLE 2
Ranking of levels of light fastness

| Color difference (ΔE) | Ranking |
|---|---|
| >11.6 | 1 |
| 11.5˜8.21 | 1-2 |
| 8.20˜5.76 | 2 |
| 5.75˜4.06 | 2-3 |
| 4.05˜2.91 | 3 |
| 2.90˜2.06 | 3-4 |
| 2.05˜1.36 | 4 |
| 1.35˜0.46 | 4-5 |
| <0.45 | 5 |

2. Chromatic Strength

The reflectance at maximum absorption wavelength of the specimen was converted into K/S value and chromatic strength as well as apparent strength were calculated according to the following equations:
Chromatic strength={[K/S(sample)]/[K/S(standard)]}×100
Apparent strength={Σ[K/S(sample)]/Σ[K/S(standard)]}×100

Chromatic strength was more commonly used. If there are 2 or 3 maximum absorption wavelengths in the absorption spectra of the specimen, apparent strength was used instead. In the context of this invention, the chromatic strength was used throughout.

D. Structural Identification of Dye-A, -C, -E, -E′ and -G

The molecular weight and the molecular fragments could be obtained through analysis by mass spectroscopy. By virtue of H-NMR, the position of a functional group on the molecule could be derived (Signals in DMSO-d6: δ 2.50 ppm was the solvent peak; δ 3.55 ppm was the peak of H in H₂O). By combining both informations obtained from two spectra described above, structures of the inventive dyes were identified and were shown in following tables (Table 3-7).

TABLE 3
Structural determination of the inventive dye-A

| | | |
|---|---|---|
| Dye No. | A | |
| Molecular weight | 674.57 | |
| MS-FAB⁻ | (1) 673/ [M—H]⁻ | |
| (m/z) | (2) 695/ [M + Na—2H]⁻ | |
| | (3) 717/ [M + 2Na—3H]⁻ | |
| NMR | (1) 2.80˜2.90 [4H, (a)˜(b)] | (4) 10.42 [2H, NH₂] |
| δ (ppm) | (2) 7.10˜8.20 [7H, Ar, (c)˜(i)] | (5) 12.88 [1H, OH] |
| | (3) 10.29 [broad, 2NH] | |

| | |
|---|---|
| Structural formula | 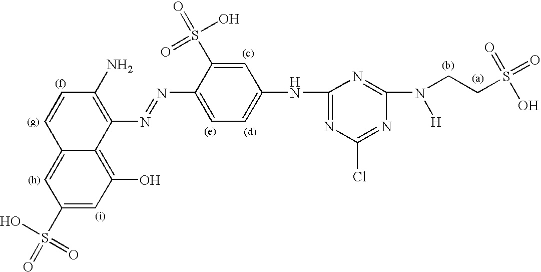 |

TABLE 4
Structural determination of the inventive dye-C

| | | |
|---|---|---|
| Dye No. | C | |
| Molecular weight | 619.52 | |
| MS-ESI⁻ | (1) 640 [M + Na—H]— | |
| (m/z) | (2) 642 [M + Na—H]— (with Cl³⁷) | |
| | (3) 662 [M + 2Na—H]— | |
| NMR | (1) 2.71˜2.74 [4H, (a)˜(b)] | (4) 10.80 [broad, NH₂] |
| δ (ppm) | (2) 7.15˜7.92 [7H, Ar, (c)˜(i)] | (5) 12.37 ο1H, OH] |
| | (3) 9.61 [broad, 2NH] | |

| | |
|---|---|
| Structural formula | 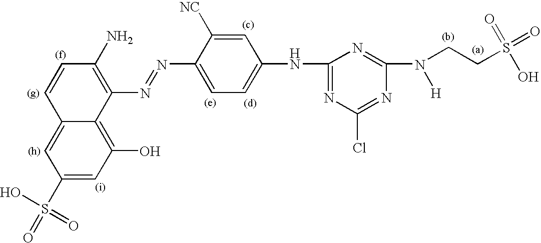 |

TABLE 5
Structural determination of the inventive dye-E

| | |
|---|---|
| Dye No. | B |
| Molecular weight | 711.05 |
| MS-FAB⁻ | (1) 710.0 [M—H]⁻ |
| (m/z) | (2) 732.0 [M + Na—2H]⁻ |
| NMR | (1) 7.16 [11H, Ar, (a)˜(k)] |
| δ (ppm) | (2) 9.21 [broad, 2NH] |
| | (3) 10.80 [broad, NH₂] |
| | (4) 12.88 οbroad, OH] |
| Structural formula | 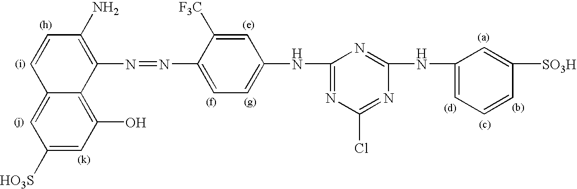 |

TABLE 6
Structural determination of the inventive dye-E′

| | | |
|---|---|---|
| Dye No. | E′ | |
| Molecular weight | 662.51 | |
| MS-FAB⁻ | (1) 661.0 οM—H]⁻ | |
| (m/z) | | |
| NMR | (1) 2.70˜2.75 [4H, (a)˜(b)] | (4) 10.63 [2H, NH₂] |
| δ (ppm) | (2) 7.10˜8.46 [7H, Ar, (c)˜(i)] | (5) 12.45 [1H, OH] |
| | (3) 10.49 [2H, 2NH] | |

| | |
|---|---|
| Structural formula | 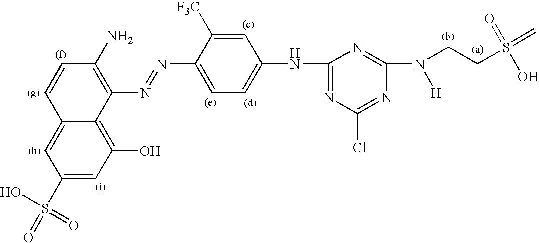 |

TABLE 7
Structural determination of the inventive dye-G

| | | |
|---|---|---|
| Dye No. | G | |
| Molecular weight | 593.50 | |
| MS-FAB⁻ | (1) 592.9 [M—H]⁻ | |
| (m/z) | (2) 614.9 [M + Na—2H]⁻ | |
| | (3) 637.0 [M + 2Na—3H]⁻ | |
| NMR | (1) 2.5˜2.8 [4H, (a)˜(b)] | (4) 10.47 [2H, NH₂] |
| δ (ppm) | (2) 7.2˜8.1 [8H, Ar, (c)˜(j)] | (5) 12.75 [1H, OH] |
| | (3) 10.31 [2H, 2NH] | |

| | |
|---|---|
| Structural formula | 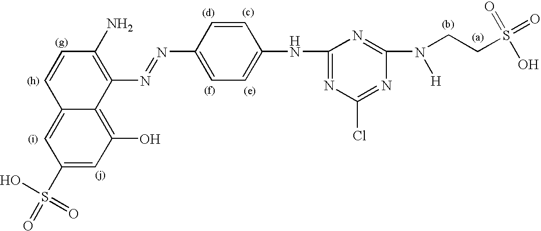 |

E. Test Results of Properties of Inks

Inventive dyes-A, E and E′ (with salts not removed) were formulated in inks, their formulations and properties shown in Table 8 and 9.

TABLE 8
Formulation of inventive inks

| | Components | Ratio (wt %) |
|---|---|---|
| Main solvent | Deionized water | 67.5 |
| Humectant and | P.E.G (Polyethylene | 30.0 |
| viscosity adjusting | glycol) .#200 | |
| agent | | |
| Colorant | Inventive dye A, E | 2.0 |
| | and E′ | |
| Adjustment of pH | Citric acid buffer | 0.5 |
| | solution (pH = 4.65) | |

TABLE 9
Test results of properties of inks

| | η | σ | Density | | Centrifugation |
|---|---|---|---|---|---|
| | (cp) | (dyne/cm) | (g/cm3) | pH | test |
| Inventive ink-A | 4.055 | 32.91 | 1.05 | 4.65 | homogeneous |
| Inventive ink-E | 4.927 | 34.50 | 1.04 | 4.77 | homogeneous |
| Inventive ink-E′ | 4.302 | 39.10 | 1.05 | 4.20 | homogeneous |
| Commercial ink -S | 4.316 | 30.25 | 1.09 | 5.75 | very slightly |
| | | | | | precipitated |
| Commercial ink -U | 2.449 | 38.38 | 1.06 | 6.35 | homogeneous |
| EPSON 400 ink | 3.812 | 31.99 | 1.10 | 8.73 | homogeneous |

F. Ink-Jet Printing on Papers

Three commercial inks and Three inks formulated with the inventive dyes were adjusted to have same chromatic strength and then were used to jet print on three types of paper, namely, a photographic paper, a glossy paper and a A4 paper. ΔE (color difference) thereof were compared with standard magenta of Pantone card. In addition, light fastness was tested. Results were shown in Table 10-12.

1. Color Comparison with CIE Lab System

(1) Papers made of different materials had different degrees of adsorption of the ink and hence exhibited considerably different shade.

(2) Results from ink-jet prints on three types of paper indicated consistently that ΔE (color difference) between the inventive ink A (on A4 paper, glossy paper and photographic paper) and Pantone magenta was the least; then, the EPSON 400 original ink (on a photographic paper), the inventive ink E′ (on a glossy paper), and the commercial ink-S was respectively the second least.

TABLE 10
ΔE (color difference) vs Pantone magenta on photographic paper

| | | Δa | Δb | ΔE |
|---|---|---|---|---|
| | | (red- | (yellow- | (color |
| Inventive inks | ΔL | green) | blue) | difference) |
| A | 0.808 | 1.819 | −0.949 | 2.212 |
| E | −4.081 | −8.150 | −0.714 | 9.142 |
| E′ | −8.186 | −1.199 | 10.010 | 12.987 |
| EPSON 400 ink | −4.642 | −0.583 | −3.092 | 5.608 |
| Commercial ink-S | −13.356 | −1.256 | 12.441 | 18.296 |
| Commercial ink-U | −8.091 | 4.910 | 8.981 | 13.047 |

TABLE 11
ΔE (color difference) vs Pantone magenta on glossy paper

| | | Δa | Δb | ΔE |
|---|---|---|---|---|
| | ΔL | (red- | (yellow- | (color |
| Inventive inks | (shade) | green) | blue) | difference) |
| A | 0.963 | −2.717 | −3.001 | 4.161 |
| E | −5.013 | −0.662 | −4.132 | 6.530 |
| E′ | −3.791 | −3.430 | −2.092 | 5.524 |
| EPSON 400 ink | −7.717 | 5.020 | −10.323 | 13.832 |
| Commercial ink-S | −11.609 | 0.976 | 5.451 | 12.862 |
| Commercial ink-U | −7.082 | 1.815 | 1.240 | 7.415 |

TABLE 12
ΔE (color difference) vs Pantone magenta on A4 paper

| | | Δa | Δb | ΔE |
|---|---|---|---|---|
| | ΔL | (red- | (yellow- | (color |
| Inventive inks | (shade) | green) | blue) | difference) |
| A | −1.577 | 0.044 | −0.397 | 1.627 |
| E | 4.649 | −11.914 | −9.422 | 15.885 |
| E′ | 9.371 | −13.590 | −14.580 | 22.024 |
| EPSON 400 ink | 2.418 | −8.070 | −11.358 | 14.142 |
| Commercial ink-S | −5.666 | −0.221 | −5.658 | 8.010 |
| Commercial ink-U | −10.878 | −4.663 | −4.498 | 12.661 |

2. Light Fastness Test

Light fastness test was performed on ink-jet printed papers and as results shown in Table 13, the inventive ink A exhibited the highest light fastness on A4 paper and photographic paper, while other inks were only at 1-2 level.

TABLE 13
Light fastness

| Items | A4 paper | Glossy paper | Photographic paper |
|---|---|---|---|
| Inventive ink-A | 3 | 1 | 2 |
| Inventive ink-E | 1 | 1-2 | 1 |
| Inventive ink-E′ | 1-2 | 1-2 | 1-2 |
| EPSON 400 ink | 1-2 | 1 | 1 |
| Commercial ink-S | 1-2 | 1-2 | 2 |
| Commercial ink-U | 2 | 1 | 1-2 |

G Ink-Jet Printing on Cotton Fabrics

Before ink-jet printing, cotton fabrics were pretreated with a composition comprising: 50 parts of a 6% aqueous solution of sodium alginate thickening agent, 5 parts of urea, 0.3 parts of chelating agent, 2 parts of sodium bicarbonate, 1 part of sodium chloride and 41.7 parts of water. The fabrics should be througthly soaked with the pretreatment composition in a padding bath and the excess liquor removed by mangling. The fabrics should then be dried in hot air, for example at a temperature of 90 to 110° C. prior to ink-jet printing. After printing the fabrics were steamed for ten minutes at 100˜105° C., and then washed with a aqueous solution of 1 g/l detergent for five minutes at 80° C., subsequently washed with warm water (50° C.) and water.

1. Color Comparison with CIE Lab System

Color comparison was carried out on ink-jet printed cotton, respectively, with two commercial reactive magenta inks and three inventive inks with reference to Pantone magenta. Their ΔE (color difference) were shown in Table 14. These results revealed that the ΔE (color difference) obtained from the inventive ink A was nearest to Pantone magenta.

TABLE 14
ΔE (color difference) vs Pantone magenta on cotton

| | | Δa | Δb | ΔE |
|---|---|---|---|---|
| | ΔL | (red- | (yellow- | (color- |
| Items | (shade) | green) | blue) | difference) |
| Inventive ink-A | −2.003 | −2.969 | −0.806 | 3.671 |
| Inventive ink-E | −0.823 | −4.767 | −1.213 | 4.987 |
| Inventive ink-E′ | −1.231 | −3.768 | −4.116 | 5.715 |
| Commercial ink -S | −8.463 | −7.424 | −2.819 | 11.605 |
| Commercial ink -U | −2.474 | −5.614 | −2.817 | 6.751 |

2. Fastness Tests

Fastness properties against light, washing and water were shown in Table 15. These results indicated that water fastness and washing fastness obtained from the inventive inks and the commercial inks were all higher than rank 4, met the commercial requirements. Further, the light fastness of the inventive inks was higher than those of the commercial inks.

TABLE 15
Fastness tests on cotton

| Inventive inks | Water Fastness | Washing Fastness | Light Fastness |
|---|---|---|---|
| Inventive ink-A | 4˜5 | 4 | 3 |
| Inventive ink-E | 4 | 4 | 3 |
| Inventive ink-E′ | 4˜5 | 4˜5 | 3 |
| Commercial ink-S | 4 | 4 | 2 |
| Commercial ink-U | 4˜5 | 4 | 2 |

The γ acid type reactive dye provided by the invention exhibits following advantages over conventional techniques:
1. Higher water fastness and light fastness than those from commercial inks.
2. Less color difference with reference to standard than commercial inks.
3. Inks formulated with the inventive dyes particularly applicable for inkjet printing and inkjet stamping on fibrous material.
4. Current problems associated with the larger color difference and poor fastness can be solved by combining the inventive dyes with currently available yellow, blue and black reactive dyes.

While the invention has been described with reference to preferred embodiments thereof, it should be understood that the scope of the invention is not limited by these embodiments. Many changes and modifications in the above described embodiment of the invention can, of course, be carried out without departing from the scope thereof. Accordingly, to promote the progress in science and the useful arts, the invention is disclosed and is intended to be limited only by the scope of appended claims.

1. A acid type reactive dye of the following structure: 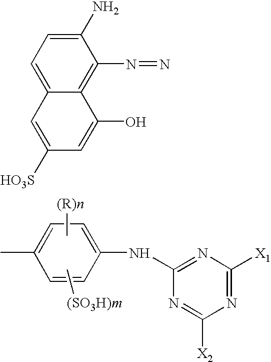
wherein R presents a C₁₋₄ alkyl, C₁-C₄ haloalkyl, or a cyano group;
n is 0, or 1;
m is 0, 1, or 2;
m and n are dependently with each other to be identical or different;
X₁ is selected form the group consisting of chlorine, 2-aminoethane sulfonic acid and α-aminobenzene sulfonic acid;
X₂ is selected form the group consisting of chlorine, 2-aminoethane sulfonic acid and α-aminobenzene sulfonic acid; and
X₁≢X₂.

2. The acid type reactive dye as recited in claim 1, wherein X₁ and X₂ are identical and are chlorine.

3. The acid type reactive dye as recited in claim 1, wherein X₁ and X₂ are identical and are fluorine.

4. The acid type reactive dye as recited in claim 1, wherein X₁ and X₂ are preferably chlorine.

5. The acid type reactive dye as recited in claim 1, wherein X₁ and X₂ are different and chlorine or 2-aminoethane-sulfonic acid.

6. The acid type reactive dye as recited in claim 1, wherein X₁ and X₂ are different and are chlorine α-aminobenzene sulfonic acid.

7. (canceled)

8. (canceled)

9. The acid type composition, comprising at least a acid type reactive dye as defined in claim 1, together with deionized water and a water miscible solvent,
wherein said reactive dye composition is for dyeing or printing a fibrous material, and in particular, for inkjet printing or inkjet stamping fibrous material.

10. The acid type composition as recited in claim 9, wherein said water miscible solvent is mostly preferably polyethylene glycol (PEG).
